(19) United States
(12) Patent Application Publication
(10) Pub. No.: US 2009/0251542 A1
(43) Pub. Date: Oct. 8, 2009

(54) SYSTEMS AND METHODS FOR RECORDING AND EMULATING A FLIGHT

(75) Inventors: Alfred COHEN, Sunnyvale, CA (US); Adi Chatow, Palo Alto, CA (US)

Correspondence Address: NIXON PEABODY, LLP, 401 9TH STREET, NW, SUITE 900, WASHINGTON, DC, 20004-2128, US

(73) Assignee: FLIVIE, INC., Palo Alto, CA (US)

(21) Appl. No.: 12/415,797

(22) Filed: Mar. 31, 2009

Related U.S. Application Data
(60) Provisional application No. 61/043,034, filed on Apr. 7, 2008.

(51) Int. Cl. H04N 7/18

(52) U.S. Cl. 348/148; 348/E07.085

(57) ABSTRACT

A mobile instrument that captures audio, video and motion/position data for a flight or other activities is described. A web service that processes the recorded data and allows a user to interact with the processed data emulating the flight or other activities is also described. Methods associated with capturing the data and processing the data are also described.

### PRIORITY

The present application claims priority to U.S. Provisional Application No. 61/043,034, filed Apr. 7, 2008, the entirety of which is hereby incorporated by reference.

### BACKGROUND

1. Field

The subject invention relates to systems and methods for recording and emulating a flight or other activities.

2. Related Art

Flight simulators are used to train new pilots and to improve the skills of experienced pilots. Flight simulators include user interfaces representative of a real plane, a display that displays a simulated flight, and a processor that provides the simulated flight to the display and monitors the user interaction with the interfaces. Typically, experienced pilots improve their skill by reacting to simulations of flight emergencies or difficult flying conditions, while new pilots react to simulations of common flight experiences such as take off and landing. The flight simulators can be used to provide feedback to the pilot about their flying skills based on their interaction with the user interfaces during the simulated flight experiences. These flight simulators, however, cannot provide feedback to the user about a real (non-simulated) flight.

Flight instructors train new pilots by flying with the new pilots until the new pilot is sufficiently experienced (e.g., at least 35 hours of flight time) and passes necessary examinations (e.g., written examinations, solo flights, etc.). The flight instructor provides the new pilot with instruction and feedback on all aspects of flying based on the flight instructor's observations during or after the flight; however, these new pilots can only rely on their flight instructor's observations to understand their strengths and weaknesses as pilots.

Planes also include black boxes that track certain aspects of a flight such as instrument data and audio data. There are actually two boxes: a flight data recorder that records flight performance data and a cockpit voice recorder that records cockpit audio, ambient sounds and communications between the pilot and air traffic controller. The boxes are designed so that the black box data can be examined to determine the cause of the flight in the event of a crash or emergency. The black box data, however, is not accessed unless there is a crash or emergency and is not for the pilot's use.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, a system for recording activity in a vehicle that includes a processor; memory coupled to the processor; a first video input coupled to a first camera and configured to provide video data to the processor from a first perspective; a second video input coupled to a second camera and configured to provide video data to the processor from a second perspective; and an audio input configured to provide audio data to the processor.

The processor may be configured to synchronize the video data from the first video input, the video data from the second video input and the audio data.

The system may also include a data input coupled to instrumentation of the vehicle.

The system may also include a data input coupled to digital instrumentation of the vehicle and configured to provide instrumentation data to the processor, and wherein the processor is configured to synchronize the instrumentation data with the video data from the first video input, the video data from the second video input and the audio data.

The system may also include a removable memory card coupled to the processor and the memory.

The system may also include a motion input coupled to an accelerometer.

The system may also include an accelerometer coupled to the processor and wherein the processor is configured to synchronize the motion data from the accelerometer with the video data from the first video input, the video data from the second video input and the audio data.

The system may also include a position input coupled to a Global Positioning System (GPS) device.

The processor is configured to determine the position of the vehicle, and wherein the processor is configured to synchronize the position data with the video data from the first video input, the video data from the second video input and the audio data.

The vehicle may be selected from the group consisting of a plane, a glider, a boat, a car, a truck, a snowmobile, an air balloon, a helicopter, and a parachute.

According to another aspect of the invention, a system is provided for recording activity in a vehicle that includes a mobile recording instrument to record activity in the vehicle; a memory card insertable into the mobile recording instrument to transfer data from the mobile recording instrument; and a web service configured to receive data from the memory card and generate a user interface for displaying the recorded activity.

The recorder may include a processor, memory coupled to the processor, a first video input coupled to a first camera, a second video input coupled to a second camera, and an audio input coupled to a speaker.

The processor may be configured to synchronize the video data from the first camera, the video data from the second camera and the audio data from the speaker.

The web service or the processor may be configured to synchronize the video data from the first camera, the video data from the second camera and the audio data from the speaker.

The system may also include an accelerometer coupled to the processor.

The processor may be configured to determine position information of the vehicle.

According to a further aspect of the invention, a method is provided that includes receiving video data from a first video source and a second video source; receiving audio data; receiving motion data from an accelerometer; receiving position data from a GPS device; and synchronizing the video data, audio data, motion data and position data to emulate a flight.

The method may also include generating a user interface for displaying the emulated flight and displaying the emulated flight in the user interface.

The method may also include receiving annotation data, processing the annotation data and displaying the emulated flight with the annotation data.

The method may also include transmitting at least some of the data received to an external controller during the flight.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a system diagram according to one embodiment of the invention.

FIG. 2 is a functional system diagram of the system of FIG. 1 according to one embodiment of the invention.

FIG. 3 is a schematic drawing of the input signals to the recording instrument according to one embodiment of the invention.

FIG. 4 is a block diagram of data flow between the recording instrument and a monitoring and control center according to one embodiment of the invention.

FIG. 5 is a flow diagram of a process for recording a flight according to one embodiment of the invention.

FIG. 6 is a flow diagram of a process for emulating a flight according to one embodiment of the invention.

FIG. 7 is a detailed flow diagram of a process for annotating flight data according to one embodiment of the invention.

FIG. 8 is a detailed flow diagram of a process for transferring and synchronizing flight data according to one embodiment of the invention.

FIG. 9 is a detailed flow diagram of a process for analyzing a flight and generating a flight plan according to one embodiment of the invention.

FIG. 10 is a detailed flow diagram of a process for cleaning propeller noise from video according to one embodiment of the invention.

FIG. 11 is a computer system diagram according to one embodiment of the invention.

### DETAILED DESCRIPTION

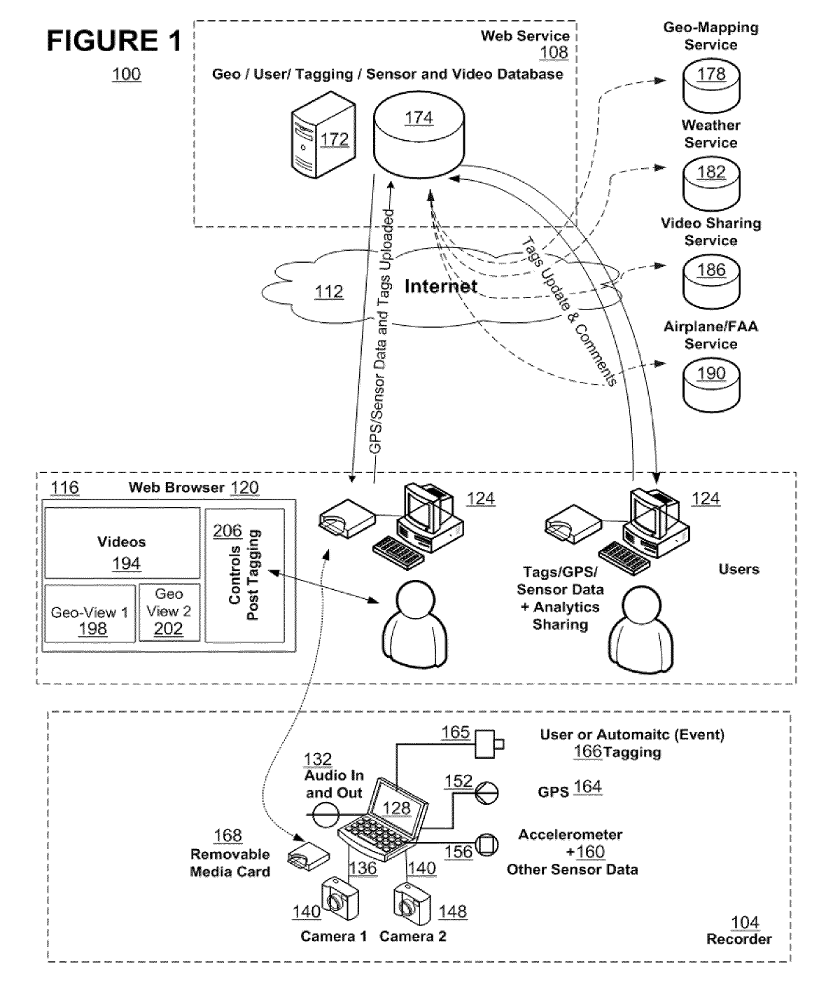

An embodiment of the invention will now be described in detail with reference to FIG. 1. FIG. 1 illustrates an activity emulation system 100. In the present specification, the activity emulation system 100 is described with reference to a flight in a private plane. It will be appreciated, however, that the activity emulation system 100 or aspects of the activity emulation system 100 may be used to emulate other activities in other sport or transportation devices, such as gliders, boats, snowmobiles, parachuting, cars, air balloons, helicopters, and the like.

As shown in FIG. 1, the activity emulation system 100 includes a mobile recording instrument 104 which may be coupled to a web service 108 via a network 112. In one embodiment, the mobile recording instrument 104 is configured to record data about the activity to be emulated, and the web service 108 can be used to analyze and correlate the recorded data to emulate the activity.

The mobile recording instrument 104 and the web service 108 are configured to enable communication with the network 112, directly or indirectly, to allow for data transfer between the mobile recording instrument 104 and the web service 108. The network 112 may be a local area network (LAN), wide area network (WAN), a telephone network, such as the Public Switched Telephone Network (PSTN), an intranet, the Internet, or combinations thereof.

In one embodiment, the web service 108 generates a user interface 116 that is accessed via a web browser 120 on a user computer 124. The user interface 116 allows the user to access the emulated activity from the web service 108 through the web browser 120 on the user computer 124. The user computer 124 is also characterized in that it is capable of being connected to the network 112, and may be a mainframe, minicomputer, personal computer, laptop, personal digital assistant (PDA), cell phone, and the like.

The mobile recording instrument 104 will now be described in further detail. The mobile recoding instrument 104 is configured to capture visual data, audio data and motion data about the activity to be emulated. As shown in FIG. 1, the mobile recording instrument 104 includes a data processing device 128 that includes an audio input 132, a first video input 136 coupled to a first video camera 140, and a second video input 144 coupled to a second video camera 148. The mobile recording instrument 104 may also include a motion input 152 coupled to an accelerometer 156 (or other motion sensor), a position input 160 coupled to a GPS device 164 and/or a tag input 165 coupled to a tagging device (e.g., a user interface such as, for example, a remote control). The flight emulation system 100 may also include a removable media card 168 (e.g., a flash memory card) insertable into the mobile recording instrument 104.

The video cameras 140, 148 are configured to capture video from two different perspectives. For example, video camera 140 may be set to a short focal distance for instrument reading or recording the actions of the pilot, while video camera 148 is set to a long focal distance for a view of the horizon. It will be appreciated that the mobile recording instrument 104 may have three or more cameras in other embodiments (e.g., a first camera pointed at the pilot, a second camera pointed at the instrument panel and a third camera pointed at the horizon).

The audio input 132 is configured to capture the plane radio, intercom audio and cockpit audio. It will be appreciated that the audio input 132 may include three separate inputs (e.g., one for each of the plane radio, intercom audio and cockpit audio). In another embodiment, the audio input 132 may include a single input with an adapter to receive multiple audio inputs. The audio data may be used for in-flight real-time information delivery. For example, the data processing device 128 may perform a text to speech conversion process to deliver audio information using the plane intercom system directly to the pilot and/or instructor. This information may include, for example, predefined thresholds (e.g., speed, course, location, etc.), anomalies (e.g., low battery of the data processing device 128, video camera not connected, etc.), confirmation of tagging and/or annotating, and the like.

The accelerometer and GPS inputs 152, 160 enable a 3 D mapping of the actual flight path. The 3 D location (i.e., including altitude) may be captured by the GPS device 164 for mapping the position of the vehicle during the flight.

In one embodiment, the video inputs 136, 144, accelerometer input 152, and GPS input 160 are universal serial bus (USB) ports of the data processing device 128, and the audio input is an audio jack of the data processing device 128.

It will be appreciated that if one or more of the video cameras are 3 D geotagged video cameras then the separate GPS input 164 is not required. Similarly, the data processing device's microphone or a microphone on one or more of the video cameras may record audio data (i.e., no separate audio recording data required) in which case the separate audio input 132 may not be required.

In one embodiment, the mobile recording instrument 104 also has an instrument input (not shown) coupled to the plane's instruments for recording flight performance data and replaying the flight or other activity captured with the mobile recording instrument 104 with the flight performance data.

In one embodiment, the mobile recording instrument 104 also includes a pilot input (not shown) coupled to a pilot data sensor coupled to the pilot. The pilot data sensor may be a heart rate monitor that can be used to gauge the pilot's excitement level, track the pilot's health for legal/insurance issues, and the like.

The data processing device 128 includes at least a processor and memory. In one embodiment, the memory is a SS drive (e.g., a flash drive with 4 GB or more memory) to store the input data. The data processing device 128 (e.g., an Atom processor available from Intel) is configured to store all of the data received from the data streams. It will be appreciated that the data processing device 128 may store the data on its own memory, store the data directly to the removable media card 168 or both its own memory and the removable media card 168.

In one embodiment, the data processing device 128 is configured to add time stamps to the multiple data streams (i.e., video x2, audio, GPS, motion, etc.) so that the data streams can be synchronized. In other embodiments, the data processing device 128 may synchronize the data itself.

In one embodiment, the data processing device 128 may control the video capture of the video cameras 140, 148. For example, the frames per second and digital zoom of the video cameras may be adjusted based on the plane type (i.e., using a look-up table). It will be appreciated that the data processing device 128 may execute program code that calculates the frames/sec and digital zoom based on the plane type, activity or other factors. For example, student pilots must perform a 30 degree turn to become certified. In this example, the camera can be adjusted to focus on nose of the plane together with the horizon so that the student can review whether the nose of the plane was kept level with horizon as required during a 30 degree turn. In another example, student pilots must learn to get out of a stall. In this example, the camera can be adjusted to watch whether the student is pulling up too much or applying power during the stall.

The tagging device 166 may allow for automatic tagging or manual tagging of the flight data. In manual tagging, the tagging device 166 may allow users to identify events of interest during the activity by interacting with a user interface such as a remote control coupled to the data processing device 128. For example, if an instructor identifies an area of improvement for a student pilot, the instructor can tag the recorded data to indicate that improvement is needed at a certain time in the activity. In automatic tagging, the digital instruments of the plane may trigger automatic tagging of the flight data if certain events are detected (e.g., too high, too fast, etc.). In another example, the accelerometer may trigger tagging if unexpected motion is detected. In yet another example, automatic tagging may be triggered according to expected motion and profiles (e.g., tag all takeoffs based on motion of speed of vehicle exceeding 50 m/h, accelerating from 30-50 mph in less than 60 s, etc.). Metatags may also be applied to the flight data (automatically or manually). Metatags include data about the plane, pilot, type of flying, etc. that may be accessed through a look-up table or may be entered manually.

The mobile recording instrument 104 is also configured to receive a removable media card 168. The user computer 124 is configured to receive the removable media card 168. The user can then upload the data from the removable media card 168 to the web service 108 over the network 112. In other embodiments, the data can be uploaded using a standard connection or uploaded wirelessly.

It will be appreciated that in alternative embodiments, data stored at the mobile recording instrument may be wirelessly transmitted to the user computer 124 or directly transmitted to the web service 108. In addition, portions of data may be transmitted directly to the web service 108 or another external service (not shown) from the mobile recording instrument 104, while other portions of the data may be transmitted using the removable media card 168. For example, since video data and audio data typically require a greater amount of bandwidth to transfer that data, the video data and audio data may be transmitted using the removable media card 168, while the GPS data and annotations may be transmitted directly to the web service 108. In another example, the data processing device 128 itself may be used to review the flight data. Software for analyzing and emulating the recorded flight data may be downloaded to the data processing device 128 or the user may simply replay the video or audio data from the data processing device 128. it will be appreciated that in embodiments in which data is transmitted directly from the data processing device 128 to the web service or the flight data is emulated at the data processing device 128, the removable media card 168 is not required.

In one embodiment, the removable media card (e.g., an SD card) may include a user profile that can be uploaded to the data processing device 128. The user profile may include information about the user such as, for example, a pilot certificate, level, plane type and the like. In one embodiment, the user profile is downloaded to the removable media card 168 from the web service 108. The user profile may be encrypted so that the mobile recording instrument can only be used if the media card 168 with the user profile is provided.

The mobile recording instrument 104 may be mounted to the plane and/or people in the plane. For example, the recording instrument 104 may be mounted on a jig on the ceiling of the plane above the crew or as a module attached to the pilot helmet, etc. The mobile recording instrument 104 may be powered by battery, so that the mobile recording instrument 104 may be easily moved from plane to plane. In other embodiments, each plane may have its own mobile recording instrument 104. In this embodiment, users simply bring their own removable media card 168 or transfer the data directly from the mobile recording instrument 104 to a user computer 124 or the web service 108.

It will be appreciated that the mobile instrument device 104 can run continuously if connected to electricity or until battery power ends with an option of cycling the memory until an interesting event occurs and by a manual trigger the last cycle of capture is saved (e.g., last 2 hours). In other embodiments, recording may be triggered automatically based on motion of the plane (e.g., start and stop). For example, the video may be controlled for start/stop of recording based on GPS/accelerometer sensing. The mobile recording instrument may send a signal to the video camera(s) to start recording when the motion sensor (e.g., accelerometer) moves at a speed more than a certain value (e.g., 10 knots) for a certain amount of time (e.g., 10 seconds) and another signal to stop recording when the speed is less than a certain value (e.g., 20 knots) for a certain amount of time (e.g., 5 sec). These default values may depend on factors, such as the type of vehicle recorded (e.g., plane type, car, glider, helicopter, bike, space vehicle or other vehicle). In embodiments in which recording is manually controlled, remote control actuation, voice activation, or connecting or disconnecting connectors to the recorder ports (with or without time delay to start/stop recording) may start recording.

The web service 108 will now be described in further detail. The web service 108 integrates the data captured at the mobile recording instrument 104 and displays the integrated data to the user. The data may be displayed with annotations and other inputs provided by the instructor or users of the web service 108. The inputs are recorded and synchronized to enable playback with simultaneous views, audio and flight position. The web service combines the video and audio captures with the 3 D mapping of the flight in its different stages, the software can rerun and play back the entire flight or certain parts which are of interest to the pilot, flight instructor or the student pilot.

The hardware of the web service 108 may be a conventional server that includes at least a processor 172 and a database 174. The database 174 is stored in storage media that may be volatile or non-volatile memory that includes, for example, read only memory (ROM), random access memory (RAM), magnetic disk storage media, optical storage media, flash memory devices and zip drives. The database 174 is configured to store the data received from the mobile recording instrument 104 and the processor 172 is configured to synchronize and analyze the data.

The web service 108 may also be in communication with external services such as a geo-mapping service 178, a weather service 182, a video sharing service 186 and an airplane/FAA service 190. The web service 108 can use data received from these external services 178-190 to further analyze and synchronize this data recorded during the flight by the mobile recording instrument 104. It will be appreciated that the data from the mobile recording instrument 104 can also be provided to the external services 178-190 through the web service 108.

The processor 172 is configured to perform one or more operations, such as, correlate and synchronize the recorded data, allow for annotation or editing of annotations of the recorded data, perform statistical analyses, allow for social networking based on the emulated activity, perform analytics of the recorded data and data identified from external services, provide instruction or training to pilots, generate recommendations based on emulated activity, analyze plane performance and perform auto-tagging (e.g., type of plane, pilot, weather, time of day, type of flying, etc.). It will be appreciated that one or more of the above operations may be performed at the mobile recording instrument 104.

The web service 108 can also be used to annotate the data recorded by the mobile recording instrument 104 or edit tags applied during the activity. For example, if the flight instructor inserts a tag during a flight, the instructor can access the tag through the web service 108 to add comments about the tagged instances of the flight.

As explained above, the web service 108 is configured to generate the user interface 116 that allows a user or group of users to access the emulated activity. As shown in FIG. 1, the exemplary user interface 116 includes a video region 194, a geo-view 1 region 198, a geo-view 2 region 202 and a control region 206. For example, the video region 194 may display the video data captured using the second video camera (e.g., inside the plane) and the geo-view 1 region 198 may display the video data captured using the first video camera (e.g., the horizon). The geo-view 2 region 202 may display annotated data or flight plan data that is added to one of the views or a simulated version of the flight using the recorded flight data and, optionally, display the annotations or other markers and/or the flight plan. The control region 206 may display statistical data or other data about the flight and allow the user to interact with the displays and types of information displayed in the user interface 116.

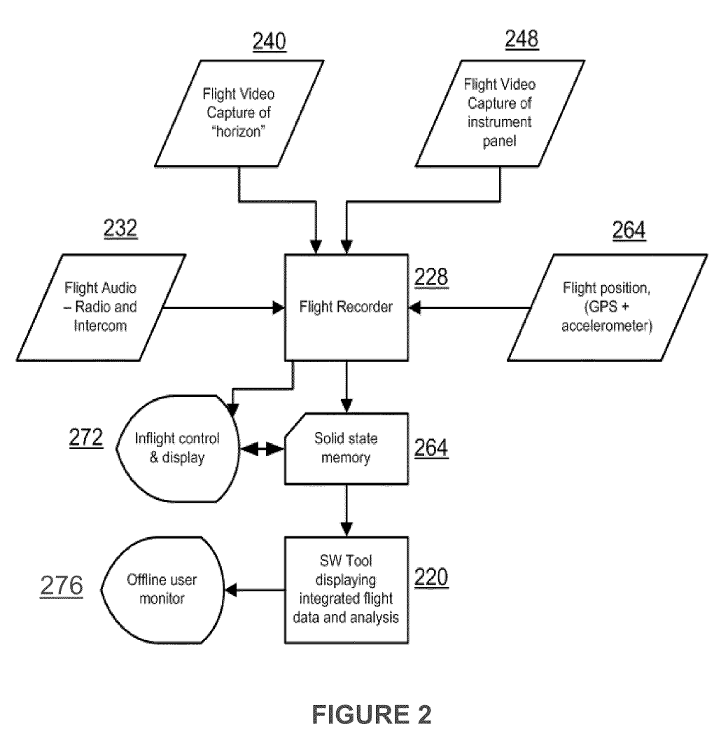

FIG. 2 is a functional system diagram 200 of the activity emulation system 100 of FIG. 1 according to one embodiment of the invention. As shown in FIG. 2, a video camera device 240 that has a focal length on the horizon and captures the field of view outside the plane looking forward and a video camera device 248 that is focused on the instrument panel and captures the main flight instruments are input to the recorder 228. Additional inputs to the flight recorder 228 are the audio and or radio input 232 and the GPS 264 and/or accelerometer 256 readings. The inputs are synchronized in time which enable a playback of all input channels simultaneously on the monitor 216 (integrated and/or remote) as controlled and displayed by the web based software tool 220. The inputs are recorded and saved on a solid state memory card (e.g., 8 GB) 264 which enables easy mobility to other computer and display devices.

The in-flight control and flight display screen 272 enable adjustment of the camera devices and basic playback operations within the crew cabin environment. The remote has an additional functional role of real time tagging and parking parts of the flight with “time signals”, by for example the flight instructor, for later analysis of the time span marked after landing or during home viewing.

The information collected in the flight recorder 228 and saved in the solid state memory 264 can be uploaded to the software tool (e.g., web site) 220 with defined access as defined by pilot or owner of the flight information. For example, a student pilot can enable his flight instructor to share information and enter remarks/tags to the stages of flight which need more attention or practice. The owner of the information can also decide to limit access to himself or share the data with a private group or public group.

The software tool 220 integrates the flight data and performs analysis of the data and can display the data at an offline user monitor 276. For example, a user can access the recorded data at a website associated with the software tool 220 to access their integrated and analyzed flight data from their personal computer at the user monitor 276.

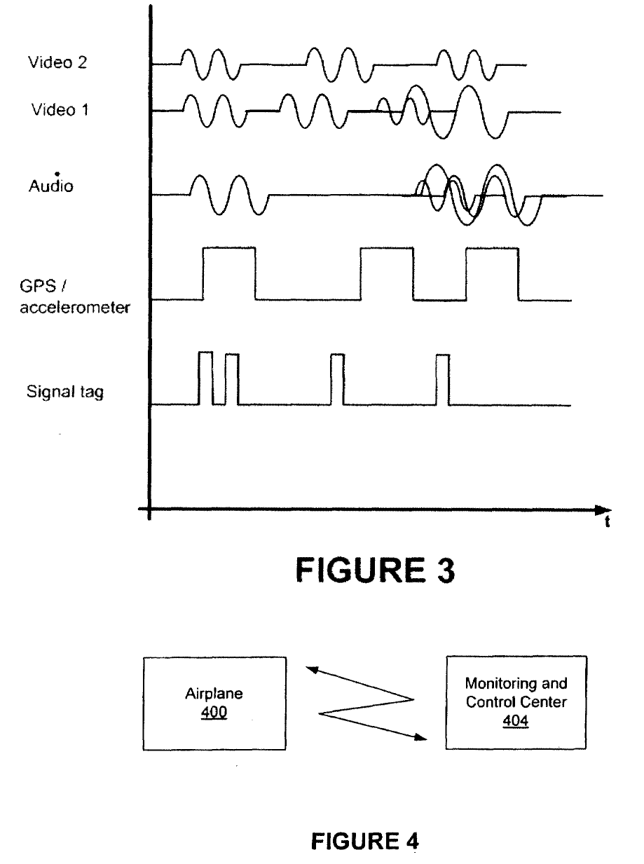

FIG. 3 illustrates exemplary signal inputs to the integrating controller. For example, in FIG. 3, the signal inputs are video capture 2 (instruments), video capture 1 (horizon), audio (pilot/instructor and radio), GPS/accelerometer and signal tag. The signal tag may be manually initiated by the pilot/instructor or predefined in time.

As shown in FIG. 4, data may be transmitted to a monitoring or control station 404 during flight (i.e., in “real time”) from the plane 400. For example, turbulence metering, video captures, airplane position, and the like, and combinations thereof, may be transmitted between the plane and the monitoring and control center. Exemplary protocols for transmitting this data include GPRS, EDGE, 3G, HSPA, and the like.

An exemplary advantage of the embodiment of FIG. 4 is generation of an automated report of air turbulence based on the accelerometer and/or GPS data recorded by the plane 400. The plane may transmit filtered data that fits the frequency of air turbulent “bumpiness” along with a certain amplitude above a predefined threshold. This data can then be translated into an intensity report of the turbulence from mild to severe along with the time, position and type of plane by the monitoring or control station 404. Another exemplary advantage of the embodiment of FIG. 4 is sharing of horizon video capture along with the GPS position and altitude data for weather and cloud reports. These data captures can be done without interrupting the pilot in command because the data sharing options can be preset by the pilot in command (PIC) before the flight or at any time during flight. These uses of the system of FIG. 4 can significantly improve the objectiveness of weather and turbulence reports for service to all planes and planned flights in the area where the data was recorded.

The system of FIG. 4 can also be used to support a safe landing of a plane if for any reason the pilot in command is not fully functional or unable to fly the plane. In this example, a crew member can share the plane sensors and video inputs with the monitoring or ground control station 404 to enable the “flight expert” in the control station 404 to guide the crew member and the plane 400 to a safe landing.

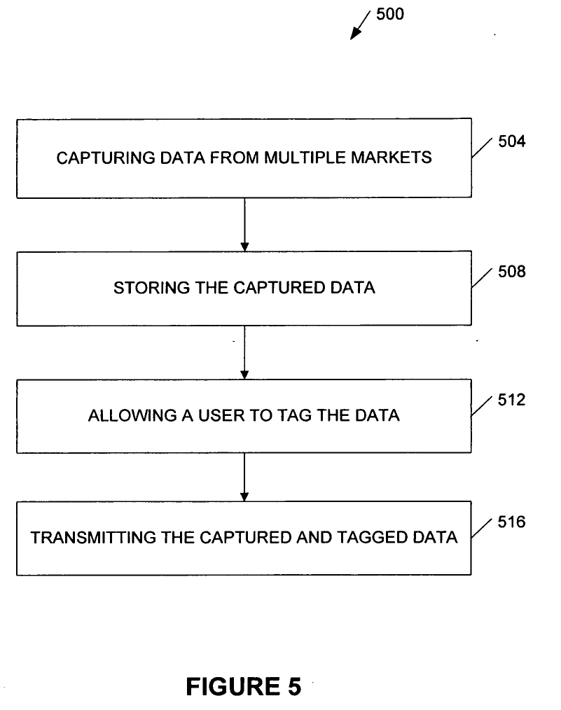

FIG. 5 illustrates a process 500 for recording flight activity according to one embodiment of the invention. It will be appreciated that the process 500 described below is merely exemplary and may include a fewer or greater number of steps, and that the order of at least some of the steps may vary from that described below.

The process 500 begins by receiving data from multiple sources (block 504). For example, video data from multiple perspectives, audio data, position data, motion data and the like can be provided to a recorder.

The process 500 continues by storing the captured data (block 508). The data that is received by the recorder can be stored at the recorder and/or on a removable media card provided in the recorder.

The process 500 optionally includes allowing a user to tag the data (block 512). For example, a user can signal with a remote control or a user interface of the recorder that an event of interest is occurring.

The process 500 continues by transmitting the captured and tagged data (block 516). The data may be transmitted in real-time, post-activity or both. In addition, some or all of the data may be transmitted using a removable media card, some or all of the data may be transmitted wirelessly, etc.

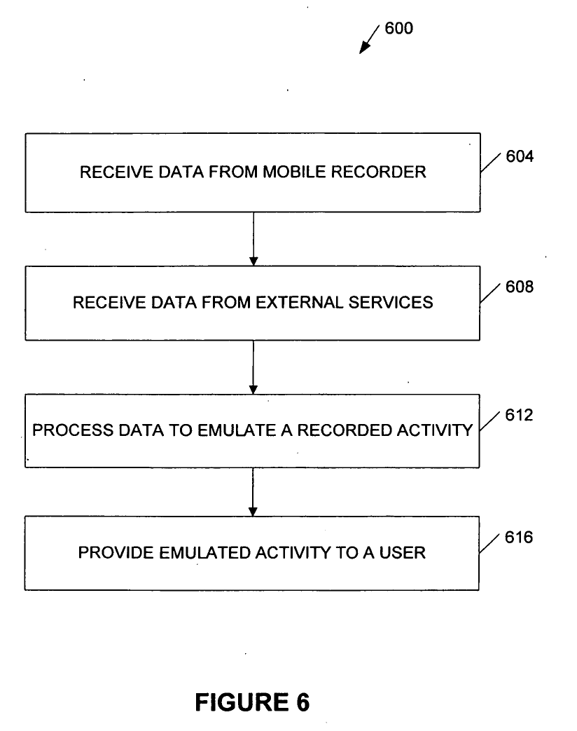

FIG. 6 illustrates a process 600 for emulating a flight according to one embodiment of the invention. It will be appreciated that the process 600 described below is merely exemplary and may include a fewer or greater number of steps, and that the order of at least some of the steps may vary from that described below.

The process 600 begins by receiving data from mobile recorder (block 604). For example, a web service may receive data from a recorder that has recorded multiple streams of data (e.g., video from different perspectives, audio, position, motion, etc.) and stores the data.

The process 600 continues by receiving data from external services (block 608). For example, the web service may receive data from, for example, a geo-mapping service, a weather service, a video sharing service and an airplane/FAA service.

The process 600 continues by processing data to emulate a recorded activity (block 612). For example, the web service may synchronize the recorded data and the data from the external service to generate a representation of the flight that can be viewed through a user interface.

The process 600 continues by providing the emulated activity to a user (block 616). For example, the web service may allow a user to access the user interface through a web browser on the user's computer.

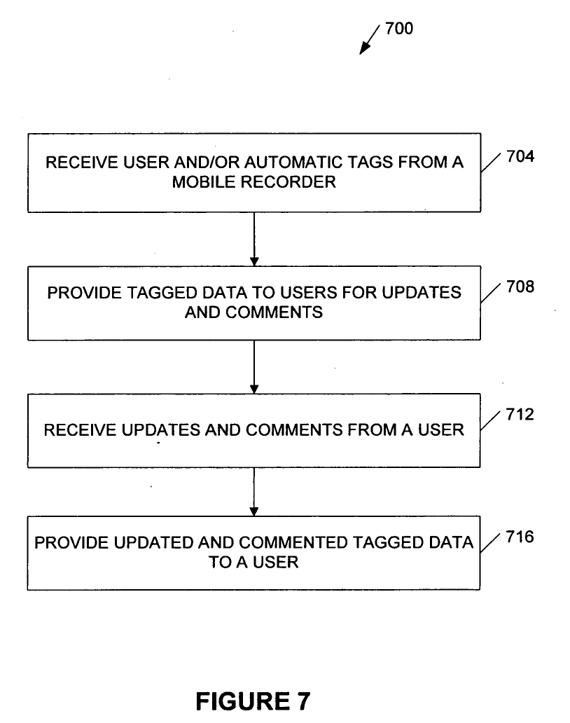

FIG. 7 illustrates a process 700 for tagging recorded and/or processed flight data according to one embodiment of the invention. It will be appreciated that the process 700 described below is merely exemplary and may include a fewer or greater number of steps, and that the order of at least some of the steps may vary from that described below.

The process 700 begins by receiving user and/or automatic tags from a mobile recorder (block 704). For example, an instructor may actuate a button on a user interface of the recorder or a button on a remote control connected to the recorder to indicate that the data should be tagged. In one embodiment, the user may also provide input that the data should stop being tagged (i.e., time of beginning of event until an end of the event). Automatic tags include, for example, the plane type, pilot type (sport, student, private, IFR, acrobatics), GPS and altitude location, velocity, airport vicinity, club association, season, weather, time of day (exact time+day, night). Auto tagging allows for search, organization and sharing of information with other users of web service to allow for social sharing, tag sharing and activity movie sharing. Auto tagging also allows for correlating other pictures and movies (e.g., taken from the plane or from ground of the plane) to create one set of captures of the “event”. For example, a video camera may be positioned near the landing strip of an airport to capture the landing of planes. The web service then combines the view from the ground with the view recorded in the plane to present multiple video captures synchronized and presented on one screen for student pilot debriefing.

The process 700 continues by providing the tagged data to users so that the users can update and comment on the received tags (block 708) and receiving the updates and comments from the user (block 712). For example, at the recorder or the web service, the instructor may add comments about the activity during the time in which the data is tagged. The process 700 continues by providing the updated and commented tagged data to a user (block 716). For example, the student may review the instructor's comments from the student's computer.

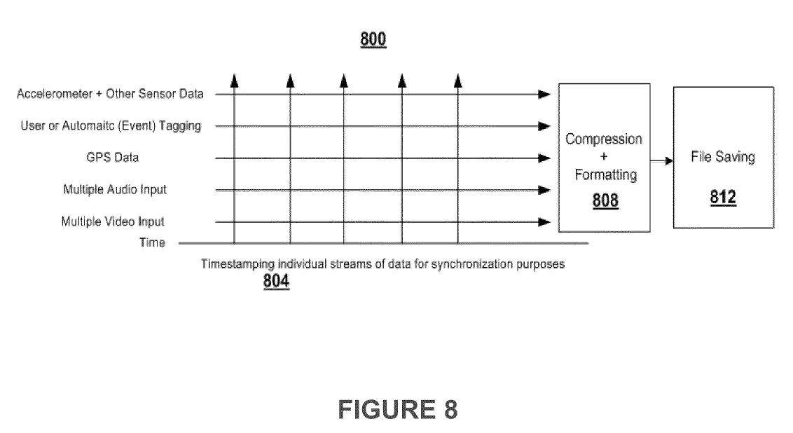

FIG. 8 illustrates a process 800 for synchronizing data from the mobile recording instrument according to one embodiment of the invention. It will be appreciated that the process 800 described below is merely exemplary and may include a fewer or greater number of steps, and that the order of at least some of the steps may vary from that described below.

The process 800 begins by time stamping individual streams of data for synchronization (block 804). For example, each of the accelerometer data, tagging data, GPS data, audio input and video input can be time stamped at multiple time periods (block 808).

The process 800 continues by compressing and formatting the data (block 808) and saving the data as a file (block 812). The file can then be transferred to a web service that can synchronize each of the data streams using the time stamps that were added at block 804. By synchronizing the data captured with the recording device, reruns of the recorded activity can be generated for sharing, analyzing and/or instructing student pilots.

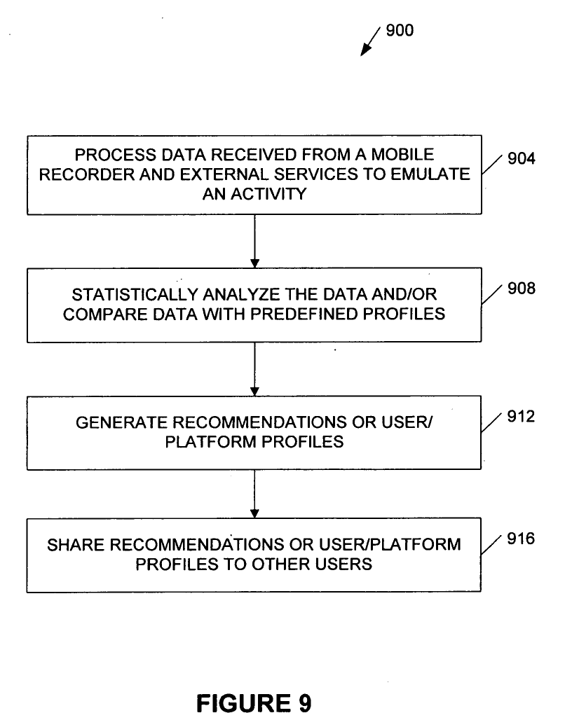

FIG. 9 illustrates a process 900 for analyzing an emulated flight to gain insights according to one embodiment of the invention. It will be appreciated that the process 900 described below is merely exemplary and may include a fewer or greater number of steps, and that the order of at least some of the steps may vary from that described below.

The process 900 begins by processing data received from a mobile recorder and, optionally, external services to emulate an activity (block 904).

The process 900 continues by statistically analyzing the data and/or compared the data with predefined profiles (block 908) and generating recommendations or user/platform profiles (block 912). For example, the collected data may be analyzed to generated recommended improvements in flight/pattern work. These recommendations can be determined using statistical data accumulated or by comparing the recorded data with a predefined profile with boundaries. For example, a landing profile for a certain plane type (e.g., C172) and a standard landing with the profile (speed, 3 d positioning vs. field in box format) can be compared to the actual (i.e., recorded) airplane data. The web service and analytics can also show where the plane deviated from the profile or parameters that deviated from the profile.

The process 900 continues by sharing the recommendations or user/platform profiles to other users (block 916). For example, landing profile statistics and graphics of “final/last leg” profile (e.g., altitude per distance from field and velocity, per plane type, per airport and per pilot type) can be presented to users to illustrate how a specific flight compared to the “average profile” of a group. The flight data can then be matched and shared based on a common profile and interests (e.g., student pilots or acrobatic flying, etc.).

In another example, the system can be used with a fishing boat to identify recommended fishing locations. For example, the position, speed, anchor location and time of day along with the weight and/or size of fish caught can be used to acquire statistical data and generate a recommendation using the web service. Videos of the location and/or catching the fish can also be provided. Other users can then search the web service to locate the recommendation and plan their own fishing trip.

The GPS data may also be calibrated based on the profile of sensor data defining landing or takeoff from an airport or landing strip. The recorded data can be matched with information from a database about the known altitudes of airports. If the absolute altitude of an airport is known from a database, the GPS can be calibrated using the profile of landing and or takeoff parameters using, in particular, the velocity and altitude changes and the GPS location.

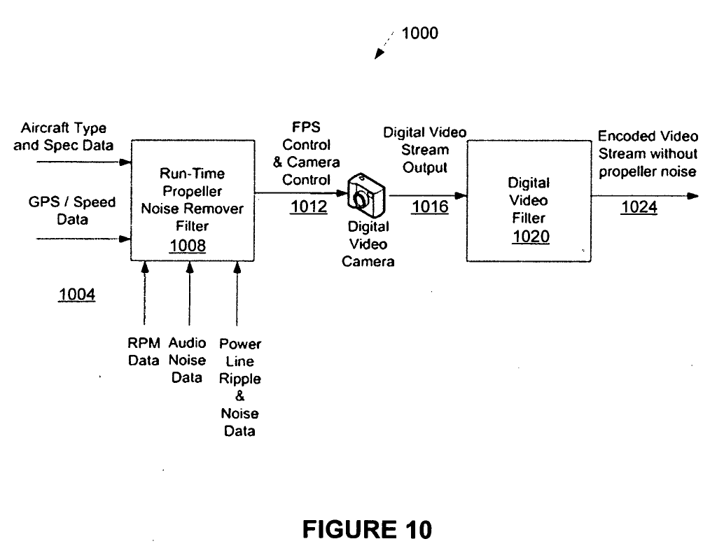

FIG. 10 illustrates a process 1000 for cleaning propeller noise from video data according to one embodiment of the invention. It will be appreciated that the process 1000 described below is merely exemplary and may include a fewer or greater number of steps, and that the order of at least some of the steps may vary from that described below.

The process 1000 begins by providing input 1004 to a run-time propeller noise remover filter 1008. Exemplary types of input include, for example, the aircraft type and spec data, GPS/speed data, RPM data, audio noise data, power line ripple and noise data, and the like. The filter 1008 can then determine the frequency of the propeller (e.g., by optical sensor RPM counter, piezo cell on plane, or directly from panel (RPM instrument)), and control the video capture 1012 of the video camera that is focused on the horizon. For example, the frames per second of the video capture can be adjusted (e.g., to be half the cycle time, locked on cycle, or double the cycle time). The digital video recorded by the camera is output 1016 to a digital video filter 1012 that outputs an encoded video stream without propeller noise 1024. It will be appreciated that in alternative embodiments the video data can be modified to remove frames that include the propeller using frequency data or other similar techniques at the web service.

Unless specifically stated otherwise, throughout the present disclosure, terms such as “processing”, “computing”, “calculating”, “determining”, or the like, may refer to the actions and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include an apparatus for performing the operations therein. Such apparatus may be specially constructed for the desired purposes, or it may comprise a general-purpose computer selectively activated or reconfigured by a computer program stored in the computer.

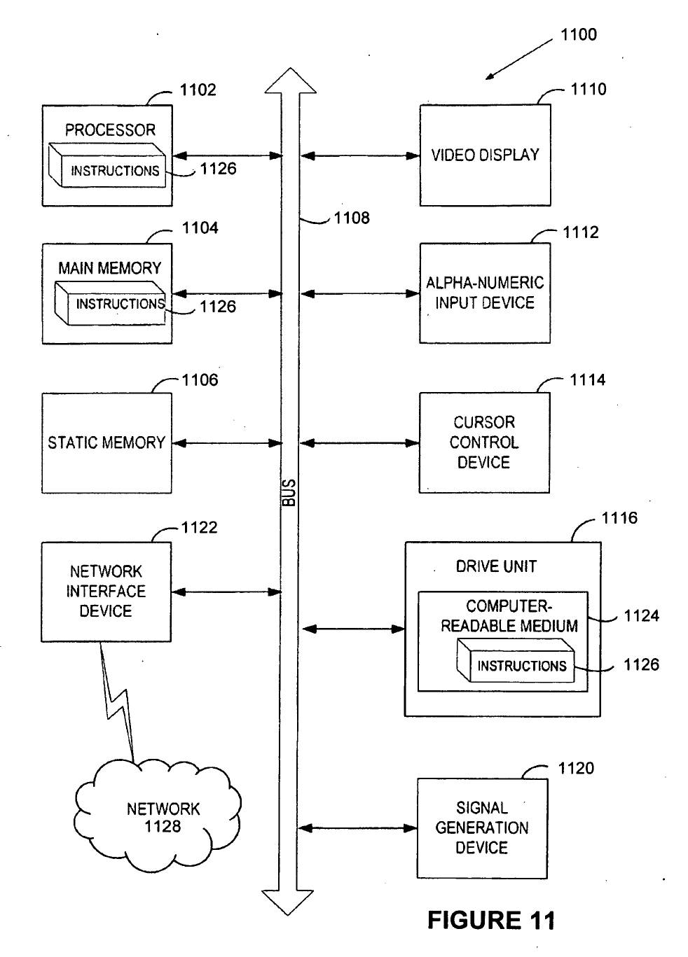

FIG. 11 shows a diagrammatic representation of a machine in the exemplary form of a computer system 1100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server, personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processor 1102 (e.g., a central processing unit (CPU), a graphics processing unit (GPU) or both), a main memory 1104 (e.g., read only memory (ROM), flash memory, dynamic random access memory (DRAM) such as synchronous DRAM (SDRAM) or Rambus DRAM (RDRAM), etc.) and a static memory 1106 (e.g., flash memory, static random access memory (SRAM), etc.), which communicate with each other via a bus 1108.

The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a disk drive unit 1116, a signal generation device 1120 (e.g., a speaker) and a network interface device 1122.

The disk drive unit 1116 includes a machine-readable medium 1124 on which is stored one or more sets of instructions (e.g., software 1126) embodying any one or more of the methodologies or functions described herein. The software 1126 may also reside, completely or at least partially, within the main memory 1104 and/or within the processor 1102 during execution of the software 1126 by the computer system 1100.

The software 1126 may further be transmitted or received over a network 1128 via the network interface device 1122.

While the machine-readable medium 1124 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier waves. The term “machine-readable storage medium” shall accordingly be taken to include, but not be limited to, solid-state memories and optical and magnetic media (e.g., any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions or data, and capable of being coupled to a computer system bus).

The invention has been described through functional modules, which are defined by executable instructions recorded on computer readable media which cause a computer to perform method steps when executed. The modules have been segregated by function for the sake of clarity. However, it should be understood that the modules need not correspond to discreet blocks of code and the described functions can be carried out by the execution of various code portions stored on various media and executed at various times.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A system for recording activity in a vehicle comprising:
a processor;
memory coupled to the processor;
a first video input coupled to a first camera and configured to provide video data to the processor from a first perspective;
a second video input coupled to a second camera and configured to provide video data to the processor from a second perspective;
an audio input configured to provide audio data to the processor.

2. The system of claim 1, wherein the processor is configured to synchronize the video data from the first video input, the video data from the second video input and the audio data.

3. The system of claim 1, further comprising a data input coupled to digital instrumentation of the vehicle.

4. The system of claim 2, further comprising a data input coupled to digital instrumentation of the vehicle and configured to provide instrumentation data to the processor, and wherein the processor is configured to synchronize the instrumentation data with the video data from the first video input, the video data from the second video input and the audio data.

5. The system of claim 1, further comprising a removable memory card coupled to the processor and the memory.

6. The system of claim 1, further comprising a motion input coupled to an accelerometer.

7. The system of claim 1, further comprising an accelerometer coupled to the processor and wherein the processor is configured to synchronize the motion data from the accelerometer with the video data from the first video input, the video data from the second video input and the audio data.

8. The system of claim 1, further comprising a position input coupled to a Global Positioning System (GPS) device.

9. The system of claim 1, wherein the processor is configured to determine the position of the vehicle, and wherein the processor is configured to synchronize the position data with the video data from the first video input, the video data from the second video input and the audio data.

10. The system of claim 1, wherein the vehicle is selected from the group consisting of a plane, a glider, a boat, a car, a truck, a snowmobile, an air balloon, a helicopter, and a parachute.

11. A system for recording activity in a vehicle comprising:
a mobile recording instrument to record activity in the vehicle;
a memory card insertable into the mobile recording instrument to transfer data from the mobile recording instrument; and
a web service configured to receive data from the memory card and generate a user interface for displaying the recorded activity.

12. The system of claim 11, wherein the recorder comprises a processor, memory coupled to the processor, a first video input coupled to a first camera, a second video input coupled to a second camera, and an audio input coupled to a speaker.

13. The system of claim 12, wherein the processor is configured to synchronize the video data from the first camera, the video data from the second camera and the audio data from the speaker.

14. The system of claim 12, wherein the web service or the processor is configured to synchronize the video data from the first camera, the video data from the second camera and the audio data from the speaker.

15. The system of claim 12, further comprising an accelerometer coupled to the processor.

16. The system of claim 12, wherein the processor is configured to determine position information of the vehicle.

17. A method comprising:
receiving video data from a first video source and a second video source;
receiving audio data;
receiving motion data from an accelerometer;
receiving position data from a GPS device; and
synchronizing the video data, audio data, motion data and position data to emulate a flight.

18. The method of claim 17, further comprising generating a user interface for displaying the emulated flight and displaying the emulated flight in the user interface.

19. The method of claim 17, further comprising receiving annotation data, processing the annotation data and displaying the emulated flight with the annotation data.

20. The method of claim 17, further comprising transmitting at least some of the data received to an external controller during the flight.
